(19) United States
(12) Patent Application Publication
(10) Pub. No.: US 2008/0295712 A1
(43) Pub. Date: Dec. 4, 2008

(54) Improved Coldset web Offset Printing

(75) Inventors: Colin Craswell, Essex (GB); Stephen Wells, Milton Keynes (GB)

Correspondence Address: DICKSTEIN SHAPIRO, 1177 AVENUE OF THE AMERICAS (6TH AVENUE), NEW YORK, NY, 10036-2714, US

(73) Assignee: Sun Chemical Corp., Parsippany, NJ (US)

(21) Appl. No.: 12/160,951

(22) PCT Filed: Jan. 23, 2007
(86) PCT No.: PCT/US2007/060917

§ 371 Date: Jul. 15, 2008

(30) Foreign Application Priority Data
Jan. 24, 2006 (GB) GB 0601400.5

(51) Int. Cl. B41M 7/00

(52) U.S. Cl. 101/128.21

(57) ABSTRACT

In a coldset web offset printing process, a substrate, e.g. newsprint, is printed with the desired matter and is then coated on both sides essentially simultaneously with a clear varnish to a film weight no more than 2 gsm dry weight on each side.

The present invention relates to an improved coldset web offset printing process.

Coldset web offset printing is most commonly used for printing newspapers, and is one of the cheapest and most economical methods of quickly printing large runs of printed matter. It is, however, generally regarded, rightly, as restrictive in the printed quality that can be achieved. The inks used consist basically of a pigment dispersed in a mineral/vegetable oil and binder and dry by absorption into the fibres of the substrate, e.g. newsprint. Particular problems experienced with this process include interpage set off (ink from one page marking an adjacent page or pages) and poor rub resistance, which results in ink coming off on the reader's hands. Thus, despite the economical process, this is not used for printing matter regarded as higher quality.

An obvious way of dealing with the problem would be to coat the printed matter with a water-based varnish that will prevent the ink from migrating either to other pages or to the hands of people holding the printed matter, and many trials of this nature have been made, all, so far as we are aware, without success. The main problems encountered were dimensional stability of the substrate and blocking, or sticking together of the web or substrate in the printing machine or post printed matter. Either of these problems by themselves would render the process unusable.

Any process used, if it is to be economically viable, must be easy to insert into a current printing process and must not add excessively to the cost. It must also not slow the overall printing process unduly. These factors are especially important when printing newspapers.

We have now surprisingly discovered that these problems may be overcome by careful selection of two printing parameters: the first is the thickness of the overprint varnish (which may be defined in terms of the film weight); the second is the timing of coating the two sides of the printed sheet—the two sides should be coated either at or about the same time.

Thus, the present invention consists in a coldset web offset printing process in which matter is printed with a coldset printing ink onto a substrate and the printed substrate is then coated with a clear varnish to a film weight no more than 2 gsm (grams per square metre) on each side, the coating on one side taking place simultaneously with or within 0.5 seconds of coating of the other.

By carrying out the coating operation in this way, so that the two sides of the substrate are coated essentially simultaneously, the curling or fluting of the paper that has been observed in previous attempts to overvarnish coldset web offset printed matter does not occur. Moreover, by keeping the applied varnish coating within the specified thickness, blocking and other sticking problems are also eliminated.

Furthermore, we have found that the applied varnish coating enhances the perceived print quality, thus leading the way for coldset web offset printing to be used for applications where it had hitherto been rejected as resulting in inadequate appearance.

There is no particular restriction on the nature of the substrate used for printing, and any substrate commonly used in coldset web offset printing may equally be used here. The substrate should preferably be porous, at least to some degree, to allow the ink to penetrate into it and thus “dry”. The preferred substrate is newsprint, but other papers may be used, whether coated or uncoated. Examples of suitable types of substrate which can be used include: uncoated paper, especially conventional newsprint and MFS (machine coated surface) types; typically having a basis weight of from 35 to 72 gsm, or coated paper, which may be matt or gloss, typically having a basis weight or from 50 to 100 gsm. Of these, we particularly prefer newsprint, typically having a basis weight of from 35 to 72 gsm.

The coldset web offset printing inks used are likewise not critical to the present invention, and any such inks commonly used in the industry may equally be used here. Examples of such inks include: Sun Chemical Classic, Polar Advantage and Superset.

Any conventional web offset printing machine may be used to print on the substrate, and more details of such equipment may be found in “Handbook of Print Media: Technologies and Production Methods”, edited by Helmut Kipphan, published by Springer-Verlag in 2001.

The overprint varnish used will be chosen having regard to the normal criteria applied when choosing a varnish to cover printed matter: it should be clear so that the printed matter is clearly visible through it; for most purposes, it should also be essentially colourless, so that it does not affect the colour balance of the print; it should be compatible with the substrate; and it should not, at least to any significant extent, dissolve the coldset web offset printing ink. The general considerations applicable to the selection of such varnishes are discussed in “Varnishes” (PrintWeek, 17 Jul. 1998, pp 39-43) and “Aqueous Coatings: A Primer” (GAFTWorld. January/February 1997, 9(1), pp 15-16).

In general, we prefer to use a water-based overprint varnish, especially an acrylic water-based overprint varnish, for example Sun Chemical VR1922W, Joncryl 90 (Johnson Polymer), Joncryl 8050 (Johnson Polymer), Vegra E375 Web Coat (ex Pomeroy), Vegra VP3406 (ex Pomeroy) or Vegra VP5505 Oil-based Duct Coating (ex Pomeroy).

Alternatively, a conventional solvent-based or UV varnish may be used, but a water-based varnish does not give rise to environmental issues and requires little energy to dry, and so is preferred.

The overprint varnish is applied to a film weight no more than 2 gsm (grams per square metre) on each side, corresponding to a total film weight of no more than 4 gsm for the two sides together. The specified film weight equates broadly to a film thickness no greater than 20 microns. The preferred film weight is no greater than 1.5 gsm on each side (i.e. a total film weight no greater than 3 gsm), still more preferably from 0.25 to 1.25 gsm, and most preferably from 0.5 to 11.0 gsm.

The conventional equipment used in, for example, newspaper printing merely needs modification to incorporate means to apply the clear overprint varnish after printing the text or other printed matter. Such equipment is well known to those skilled in the art, and, in the case of newspaper printing, may comprise a standard tower or satellite configured newspaper press. The additional means for coating the printed matter is also well known, and details may be found in, for example, “Aqueous Coatings: A Process and Equipment Primer” (GAFTWorld. March/April 1997, 9(2), pp 17-20). For example, standard roller coaters or an Anilox roller may be used.

Where, as is preferred, the overprint varnish is water-based, it will not mix easily with the oil-based coldset web offset printing ink, and may be applied as soon as practical after printing. It is essential, in order to achieve the benefits of the present invention, that the clear overprint varnish should be applied to both sides of the substrate essentially simultaneously. If coating on both sides is not essentially simultaneous, then the substrate is liable to curl or flute. In order to avoid this, if the coating is not to be simultaneous, then the second side to be coated with the overprint varnish should be coated within 0.5 seconds, more preferably within 0.3 seconds, of the first.

Although the overprint varnish is preferably applied soon after the coldset web offset printing ink has been printed onto the substrate, which will normally mean that the coldset web offset printing ink will not have dried fully, this is not necessary, and it is also possible to apply the overprint varnish to previously printed matter, on which the printing ink has already fully or partially dried.

The printing equipment may or may not be provided with heating means, e.g. means to direct hot air onto the printed or coated substrate. Where heating is available, this may aid drying. However, we have found that, where the amount of overprint varnish used is within the amounts suggested above, heating is not normally necessary in order to achieve good results.

The invention is further illustrated by the following non-limiting Examples.

### EXAMPLE 1

### Preparation of Varnish

The following components were mixed in a conventional mixer to produce a clear silk varnish:

| | |
|---|---|
| Water | 9.00 |
| Joncryl 90 (ex Johnson Polymer BV) | 44.80 |
| Joncryl 8050 (ex Johnson Polymer BV) | 13.00 |
| butyl di glycol ether BP (ex Brenntag (UK) Ltd.) | 3.00 |
| BYK 019 (ex BYK-Chemie GmbH) | 0.20 |
| water based acrylic varnish VR1922W (ex Sun | 20.00 |
| Chemical) | |
| Ultralube E810K (ex Keim-Additec Surface GmbH) | 4.00 |
| Vestowax SH112 Microwax (ex Degussa AG) | 0.50 |
| Aerosol OT75 (ex Cytec Australia Holding Pty Ltd.) | 2.80 |
| LO-VEL 27 (ex PPG Industries Inc) | 2.70 |

### Approximately 40% Solids

### Viscosity 35-40 Seconds DX20.

### EXAMPLE 2

### Preparation of Varnish

The following components were mixed in a conventional mixer to produce a clear gloss varnish:

| | |
|---|---|
| Water | 6.00 |
| Joncryl 90 (ex Johnson Polymer BV) | 65.80 |
| Butyl di glycol ether BP (ex Brenntag (UK) Ltd.) | 2.00 |
| BYK 019 (ex BYK-Chemie GmbH) | 0.20 |
| Joncryl SCX8085 (ex Johnson Polymer BV) | 12.00 |
| Water based acrylic varnish VR1922W (ex Sun | 5.00 |
| Chemical) | |
| Ultralube E810K (ex Keim-Additec Surface GmbH) | 6.00 |
| Aerosol OT75 (ex Cytec Australia Holding Pty Ltd.) | 3.00 |

### EXAMPLE 3

### Preparation and Testing of Coated Printed Material

Using the silk overprint varnish prepared as described in Example 1, a paper reel which had previously been printed in 4 colours was coated on a Moser flexo press, run at its standard speed, about a metre per second. The application Aniloxes were 11 microns and 13 microns and the heaters were set at 90° C. Both sides of the paper were coated, essentially simultaneously. At the end of the first trial, the experiment was repeated with the oven turned off and finally with both the heaters and the fans turned off. In all cases, the coating behaved well and the coated matter gave a subjective impression of quality.

The experiment was also repeated with heating, using the gloss overprint varnish prepared as described in Example 2.

Ten 10 cm*10 cm squares of the different sheets were cut and weighed so that an assessment of the amount of overprint material could be made. The average coating weights are shown in Table 1.

TABLE 1

| | |
|---|---|
| Silk (Example 1) | 3.02 gsm (coating both sides) |
| Silk (Example 1) No Heat | 3.00 gsm (coating both sides) |
| Gloss (Example 2) | 3.12 gsm (coating both sides) |

It was thought that, subjectively at least, the appearance of the print covered with the 11 micron anilox was superior. However, when tested, no variation between the two weights could be discerned.

### Static Coefficient of Friction

This was determined by the Davenport Inclined Plane Slip Test. The results are shown in Table 2.

TABLE 2

| | |
|---|---|
| Uncoated Paper | 0.420 |
| Silk (Example 1) | 0.320 |
| Silk (Example 1) No Heat | 0.315 |
| Silk (Example 1) No Heat, No Fan | 0.320 |
| Gloss (Example 2) | 0.365 |

Although the uncoated paper is quite smooth the addition of the overprint materials, particularly the silk varnish of Example 1, significantly reduced the friction.

### Rub-Off Results

The rub resistance of the coated and uncoated papers was tested with a modified Prufbau test using both untreated and squalene-soaked disks of, in this case, Holmen 42 paper. Using the Prufbau abrasion tester, each test print was rubbed with substrate disks which may or may not be squalene treated, for 10 cycles For the squalene test, disks of Holmen 42 paper were immersed in squalene, excess squalene was wiped off and the disks were dried by blotting for 15 minutes between 10 sheets of the same paper.

The amount of material abraded onto the substrate disk was measured colourimetrically after the rub cycle. The results are shown in Tables 3 (silk coating of Example 1, with heat), 4 (silk coating of Example 1, without heat), and 5 (gloss coating of Example 2, with heat). The results are reported as ΔE, and are a measure of overall colour difference taking into account both lightness and chromatic differences. Values of 0.5 to 2 are considered just perceptible

TABLE 3

| | ΔE |
|---|---|
| Silk OVP treated (Example 1 - heated) | 0.46 |
| Not OVP treated | 5.89 |

TABLE 4

| | ΔE |
|---|---|
| Silk OVP (Example 1) No Heat | 0.60 |
| Not OVP treated | 5.49 |

TABLE 5

| | ΔE |
|---|---|
| Gloss OVP treated(Example 2) | 2.32 |
| Not OVP treated | 4.99 |

Since the overprint varnish is only 40% solids, it introduces a substantial quantity of water, and so it might have been expected that there would be curling or fluting—however, this was not found to be the case, and, in fact, there was no curling or fluting at all.

The Moser press oven was set at 90° C. and, at that temperature, all the overprint varnishes performed very well, no tackiness was detected and no sticking was found on the tightly wound reels.

1. A coldset web offset printing process comprising (a) applying a coldset printing ink onto a substrate and (b) coating the printed substrate on each side with a clear varnish to a film weight sufficiently low that the coated substrate does not block or stick, the coating on one side taking place within a sufficiently short time period that the coated substrate does not flute or curl.

2. A process according to claim 1, in which the substrate is an uncoated paper.

3. A process according to claim 2, in which the substrate is newsprint.

4. A process according to claim 3, in which the newsprint has a basis weight of from 35 to 72 gsm.

5. A process according to claim 1, in which the substrate is a coated paper.

6. A process according to claim 5, in which the coated paper has a basis weight or from 50 to 100 gsm.

7. A process according to claim 1, in which the varnish is a water-based overprint varnish.

8. A process according to claim 7, in which the varnish is an acrylic water-based overprint varnish.

9. A process according to claim 1, in which the film weight of the clear varnish is no greater than 2 gsm dry weight on each side.

10. A process according to claim 9, in which the film weight of the clear varnish is no greater than 1.5 gsm dry weight on each side.

11. A process according to claim 10, in which the film weight is from 0.25 to 1.25 gsm dry weight on each side.

12. A process according to claim 11, in which the film weight is from 0.5 to 1.0 gsm dry weight on each side.

13. A process according to claim 1, in which both sides of the substrate are coated simultaneously.

14. A process according to claim 1, in which one side of the substrate is coated within 0.5 seconds of the other side being coated.

15. A process according to claim 14, in which one side of the substrate is coated within 0.3 seconds of the other side being coated.

16. A coldset web offset printing process in which matter is printed with a coldset printing ink onto a substrate and the printed substrate is then coated with a clear varnish to a film weight no more than 2 gsm dry weight on each side, the coating on one side taking place simultaneously with or within 0.5 seconds of coating of the other.

17. A process according to claim 5, in which the varnish is a water-based overprint varnish.

18. A process according to claim 5, in which the film weight of the clear varnish is no greater than 2 gsm dry weight on each side.

19. A process according to claim 5, in which both sides of the substrate are coated simultaneously.

20. A process according claim 5, in which one side of the substrate is coated within 0.5 seconds of the other side being coated.
